(19) United States
(12) Patent Application Publication
(10) Pub. No.: US 2009/0035992 A1
(43) Pub. Date: Feb. 5, 2009

(54) Camera module connector with disassembling structure

(75) Inventor: Chun-Kwan Wu, Tu-Cheng, CA (US)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/221,605

(22) Filed: Aug. 4, 2008

(30) Foreign Application Priority Data
Aug. 3, 2007 (CN) 200720041186.0

(51) Int. Cl. H01R 13/648

(52) U.S. Cl. 439/607

(57) ABSTRACT

A camera module connector (100) includes an insulative housing (1), a plurality of terminals (2) received therein, a shell (3) encircling the housing 1,and a lid 4 covering the housing (1), there are ears (411) located in the lid (4). When the connector (100) disassembled, carry the ears (411) will make disassembling easily.

### BACKGROUND OF THE INVENTION

1. Field of the Invention

The present invention relates to camera module connector, and more particularly to a camera module connector with disassembling structure. The connector includes a lid with disassembling structure for taking the lid away from the connector easily.

2. Description of Related Art

Pub. No. US 2006/0189183 A1 discloses: a camera module connector includes an insulative housing, a plurality of terminals received therein, a shell encircling the housing, and a lid covering the housing.

Referring to FIG. 1 and 2 of the Pat US 2006/0189183 A1, the lid cover almost every portion of the housing, the shell, and the terminals. Because the material of the lid is metal, the lid can prevent the camera module received in the connector from electromagnetic interference. But when camera module received in the connector abatement of action needs to take away from the connector, the lid having no structure to disassemble makes the process of repairing complex and difficult.

Hence, an improved connector is required to overcome the disadvantages of the prior art.

### SUMMARY OF THE INVENTION

Accordingly, the present invention is to provide a camera module connector, the connector includes a lid, a disassemble structure is located in the lid.

A camera module connector (100) includes an insulative housing (1), a plurality of terminals (2) received therein, a shell (3) encircling the housing 1, and a lid 4 covering the housing (1), there are ears (411) located in the lid (4). When the connector (100) disassembled, carry the ears (411) will make disassembling easily.

### BRIEF DESCRIPTION OF THE DRAWINGS

FIG. 1 is a perspective view of an electrical connector of a preferred embodiment of the present invention;

FIG. 2 is exploded view of the present invention of FIG. 1; and

FIG. 3 is a perspective view of the electrical connector as shown in FIG. 1, a lid is disassembled; and

FIG. 4 is a view in cross-section on the line 4-4 in FIG. 1; and

FIG. 5 is the other one view in cross-section on the line 4-4 in FIG. 1 when the ears were curved.

### DETAILED DESCRIPTION OF THE INVENTION

Reference will now be made to the drawings to describe the present invention in detail.

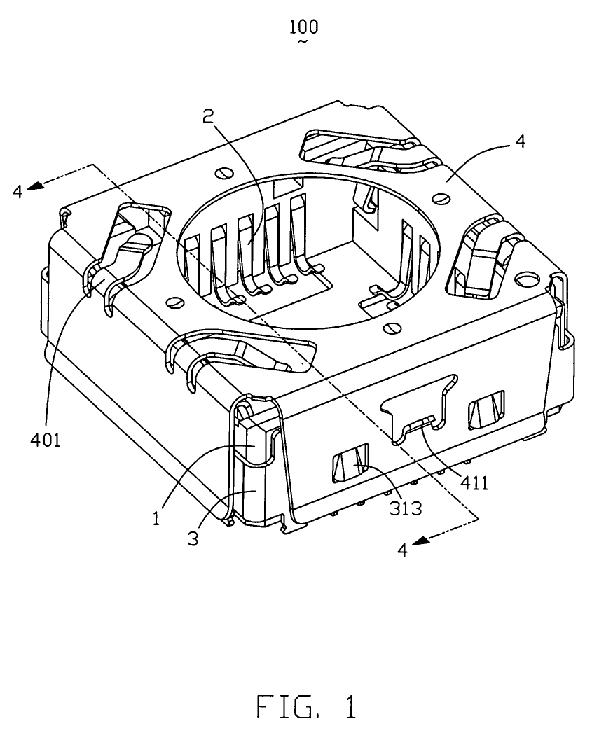

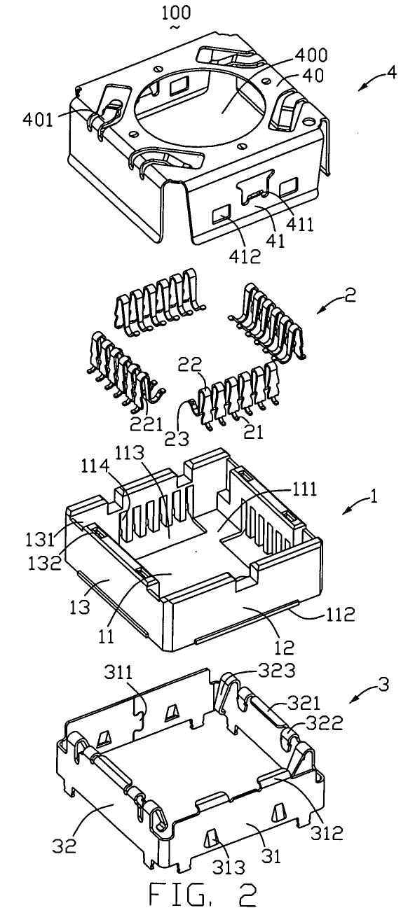

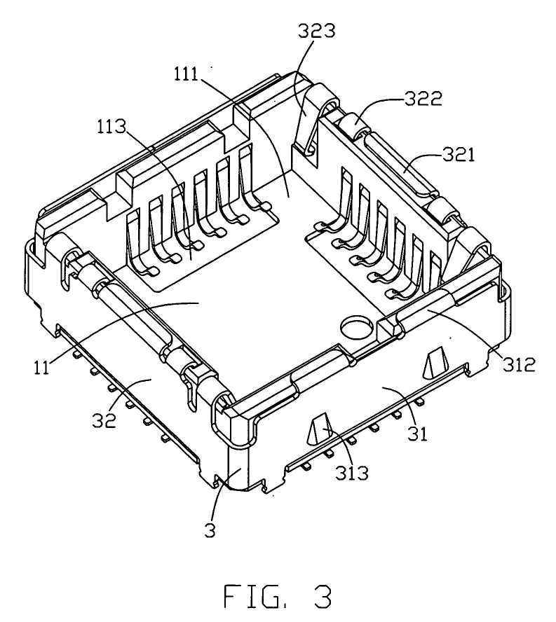

Referring to FIG. 1 to FIG. 3, the connector 100 includes an insulative housing 1, a plurality of conductive terminals 2 disposed in the housing 1, a shell 3 encircling the housing 1 and a lid 4 covering the housing 1.

The housing 1 includes a bottom wall 11, the bottom wall 11 has a mating face 111 and a mounting face 112 opposite to the mating face 111, two pairs of side walls 12,13 extend from the four edges of the bottom wall 11, and a receiving space 10 is cooperatively defined by the bottom and four side walls 11,12,13. The four side walls 12,13 include a plurality of terminal grooves 114 disposed therein, each groove 114 respectively receives a single one of the terminals 2 therein, the bottom wall 11 has four openings 113 located near the four edge sides, and the grooves 114 extend to the openings 113. Each side wall 13 includes two slots 131 set at the corner formed by the side walls 12,13 where the side wall 12,13 meet together. A number of inserting holes 132 positioned on the upper face of the side walls 13.

The shell 3 is made of an elongate metal sheet, the two tip ends of metal sheet is combined together. The shell 3 mainly assumes to be a square frame, correspondingly to the four walls 12,13 of the housing 1, the shell 3 forms four lateral walls 31,32. A number of brims 312 extend from the top end of the lateral walls 31,32, and the brims 312 vertically bent inwardly attaching to the upper face of the side walls 12,13 of housing 100. Several anchors 322 spread from the top end of the lateral walls 32. The anchors 322 are bent downwardly and inserted into the inserting holes 132. A few of blocks 313 located on the lateral walls 31 are pressed to the final state. At least one riveting portion is located on the lateral wall 31,32. A plurality of arms 323 extend from the top end of the lateral walls 31,32 inwardly to the receiving space 10.

The lid 4 assumes to be a box without bottom, includes a roof 40 and a number of plates 41 extend from the edges of the roof 40. A through hole is located in the centre of the roof 40, a plurality of fingers 401 extend from the roof 40 inwardly to the receiving space 10. Correspondingly to the blocks 313, there are recesses 412 positioned on the plates 41. At least one ear 411 is located on the plate 41.

When the connector 100 is assembled, fix the terminals 2 in the grooves 114 through the opening 113. The contact portion 23 of the terminals 2 are in the receiving space 10, and the soldering leg 21 extend outside of the receiving space 10 from the bottom of the side walls 12,13 of the housing 1, the prickles 221 secure the terminals 2 in the housing 1. Encircle housing 1 with the shell 3, the arms 323 are positioned in the slots 131, insert the anchors 322 into the inserting holes 132, and the brims 312 attach to the top surface of the side walls 12,13. Cover housing 1 receiving the terminals 2 therein and shell 3 encircling the housing 1 with the lid 4, the blocks 313 of the shell 3 match the recesses 412 of the lid 4, the fingers 401 extend inwardly to hold the camera module received therein. When the workers disassemble the connector 100, what he need do is carrying the lid 4 with the ears 411 located on the plate 41 via instrument or his hand.

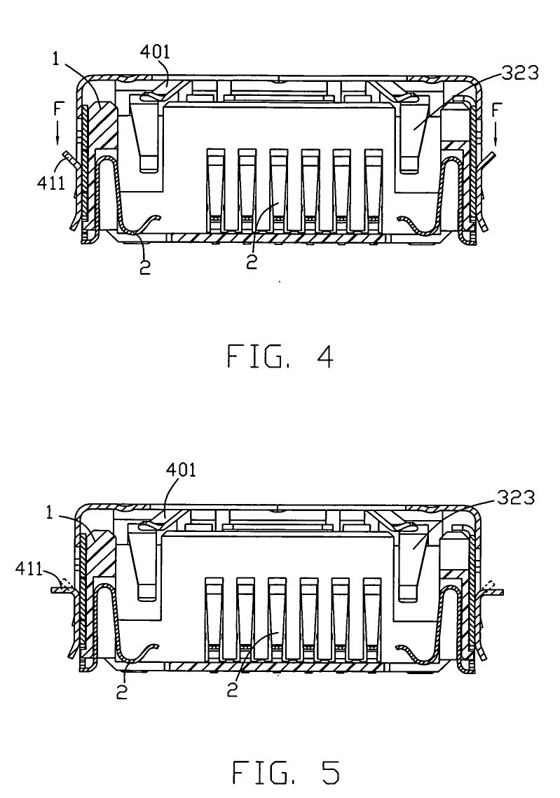

The state of disassembling is illustrated by the FIG. 4 and FIG. 5, the ears 411 be curve by the force F into the state of the FIG. 5, thus we can hold the ears 411 by fingers or other instrument.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A camera module connector, comprising:
an insulative housing and a plurality of conductive terminals disposed in the housing, a shell encircling the housing and a lid covering the housing; and
said housing including a bottom wall, four side walls and a receiving space cooperatively defined by the bottom and four side walls, said four side walls including a plurality of terminal grooves disposed therein, each groove respectively receiving a single one of said terminals therein; and
each of said terminals including a contact end extending into said receiving space and a tail end extending outside said housing; and
the shell formed by a lengthwise metal sheet, the two ends of the metal sheet combining together and forming the frame encircling the housing; and
a lid covering the housing encircled by the shell, wherein a number of ears hold by fingers or instrument when dissembling the connector are set in the lid.

2. The connector claimed in claim 1, wherein said lid assumes to be a box without bottom, said lid has a roof and a number of plates extend from the edges of the roof, said ears are located in the plate, and the end of the ear extend away from centre of the lid.

3. The connector claimed in claim 2, wherein a plurality of fingers extend from said roof inwardly to the receiving space.

3. The connector claimed in claim 2, wherein a through hole is set in the centre of the roof for part of the camera module leaning forward of the lid.

5. The connector claimed in claim 1, wherein said shell has lateral walls, a number of arms extend from said lateral walls, the arms are bent to receiving space.

6. The connector claimed in claim 1, wherein said shell and said lid fixes with each other.

7. The connector claimed in claim 6, wherein several blocks are located in the shell, and several recesses correspondingly are positioned in the lid, said blocks and recesses can match together.

8. The connector claimed in claim 7, wherein the blocks are pressed to form the final state.

9. An electrical connector comprising:
an insulative housing including a plurality of side walls and a bottom wall commonly defining an upwardly facing receiving cavity;
a plurality of contacts disposed in the housing with contacting sections extending into the receiving cavity;
a metallic shell including a top wall with at least a pair of side plates;
interengagement devices being formed on said pair of side plates and the two corresponding opposite side walls, respectively, so as to lock the shell and the housing together after said shell is downwardly assembled to the housing; and
each of said side plates is further equipped with an operation tab extending outwardly so as to allow the user to use fingers to press thereon for outwardly expanding a bottom portion of each of said side plates for disengagement of said interengagement devices of the side plate and the corresponding side wall.
